(19) United States
(12) Patent Application Publication
(10) Pub. No.: US 2005/0282636 A1
(43) Pub. Date: Dec. 22, 2005

(54) Gaming on demand system and methodology

(76) Inventor: Royal O'Brien, Jacksonville, FL (US)

Correspondence Address: Mark J. Young, Unit 202, 12086 Fort Caroline Road, Jacksonville, FL, 32225, US

(21) Appl. No.: 11/145,845

(22) Filed: Jun. 6, 2005

Related U.S. Application Data
(60) Provisional application No. 60/577,301, filed on Jun. 4, 2004.

(51) Int. Cl. A63F 13/00

(52) U.S. Cl. 463/42

(57) ABSTRACT

A system and method for gaming on demand in real time via a computer network indexes game segments and prioritizes segments of a game to be downloaded, such that segments of a game needed immediately to play at a current level are downloaded, and then portions which correspond to levels accessible from the current level are downloaded. Downloading of the portions corresponding to directly related levels, and then portions corresponding to other levels, may occur while the game is being played at a current level.

### RELATED APPLICATIONS

This application claims priority to U.S. Provisional Application 60/577,301, filed Jun. 4, 2004, the entire contents of which are hereby incorporated by reference herein.

### BACKGROUND

1. Field of the Invention

The invention relates to gaming on demand (GoD) and, more particularly, to a system and method for providing video games on demand in real time via a computer network.

2. Background Description

Video games have become increasingly complex and extremely rich in multimedia content. With the proliferation of broadband connectivity, systems have evolved that allow users to download games over a network such as the Internet, instead of having to purchase them on media, such as a game cartridge, DVD or CD-ROM. Such online systems offer users the luxury of selecting from a vast library of games. Unfortunately, however, because sophisticated video games often consume many hundreds of megabytes of storage, downloading them using conventional broadband connections can require several hours. By way of example, a 600-megabyte game may require approximately three (3) hours or more to download using a conventional DSL connection, depending upon various factors such as network congestion.

Additionally, conventional online systems require a user to download a complete executable game before play may commence. Conventional video games are typically not created in small independently executable portions. Instead, a main executable file for a video game and the necessary multimedia and data files, all of which my be required for game play, may consume hundreds of megabytes in storage and take several hours to download, even with a broadband connection. Thus, a user of such systems cannot download and play a game, without a significant delay or planning far in advance. This deficiency severely compromises the utility of conventional download-and-store gaming systems.

In an attempt to address these deficiencies, systems have emerged that divide a game into downloadable executable portions. However, they are not configured to identify, isolate and transmit only the data needed to play a game at a certain level when it is needed. Thus, if a user playing at a first level moves to a tenth level in game play, such systems tend to download all data required for game play between the first and tenth levels even though much of the data (i.e., data corresponding to levels nine through ten) are not immediately needed. Disadvantageously, a move far ahead using such systems may result in a substantial download, halting play for considerable amount of time, possibly even hours.

The invention is directed to overcoming one or more of the problems as set forth above.

### SUMMARY OF THE INVENTION

The invention solves the problems and/or overcomes the drawbacks and disadvantages of the prior art by providing a system and method for gaming on demand in real time via a computer network. An exemplary embodiment of the invention prioritizes the portions of a game that are downloaded, such that portions of a game needed immediately to play at a current level (i.e., a parent level) are downloaded, and then portions which correspond to levels accessible from the current level (i.e., descendant levels) are downloaded. Downloading of the portions corresponding to descendant levels may occur while the game is being played at a parent level.

In a first aspect of the invention, a system analyzes a conventional multi-level video game to determine all segments of all files (i.e., the assets) accessed during game play at each level of the game. A list of indices is stored on a server to provide a record of the file segments accessed per level. Thus, the indices identify the portions of a game required for play at each level. A server may then make the list available to a client to enable the client to request delivery of assets needed for play at a level of the game.

In a second aspect of the invention, a client requests assets required for play at a current level. The assets are downloaded to (and stored by) the client upon which a user may play the game. An asset must be loaded only once for a game session. After segments required for game play at a current level are downloaded, assets related to levels of play that are accessible from the current level of play are downloaded if they have not been previously downloaded during the session. Downloading of such non-current assets may occur while the game is being played. After assets related to levels of play that are immediately accessible from the current level of play have been downloaded, downloading may continue with other assets in the hierarchy that have not been previously downloaded during the session.

### BRIEF DESCRIPTION OF THE DRAWINGS

The foregoing and other objects, features and advantages of the present invention will become better understood with reference to the following description, appended claims, and accompanying drawings, where:

FIGS. 1-3 provide high-level flow charts of an exemplary process according to principles of the invention.

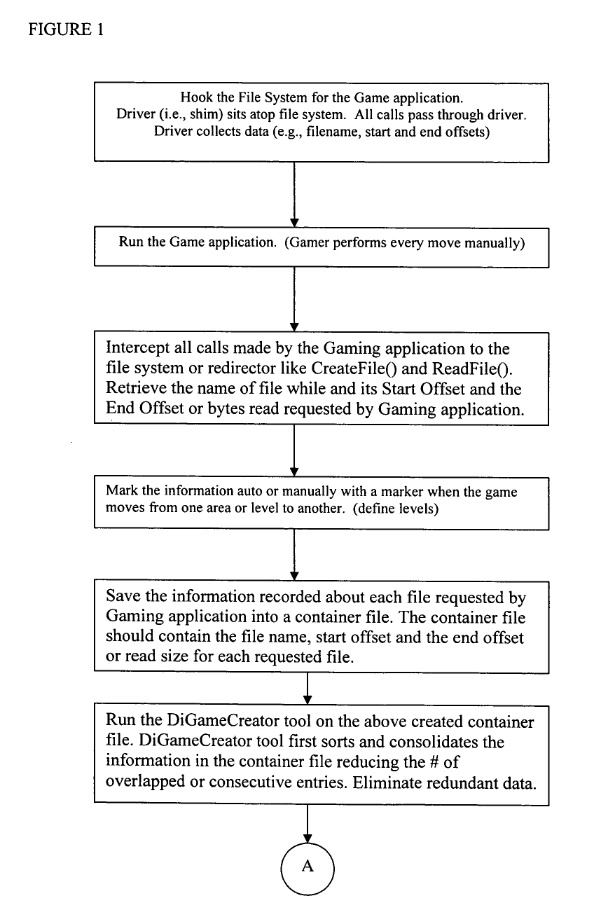

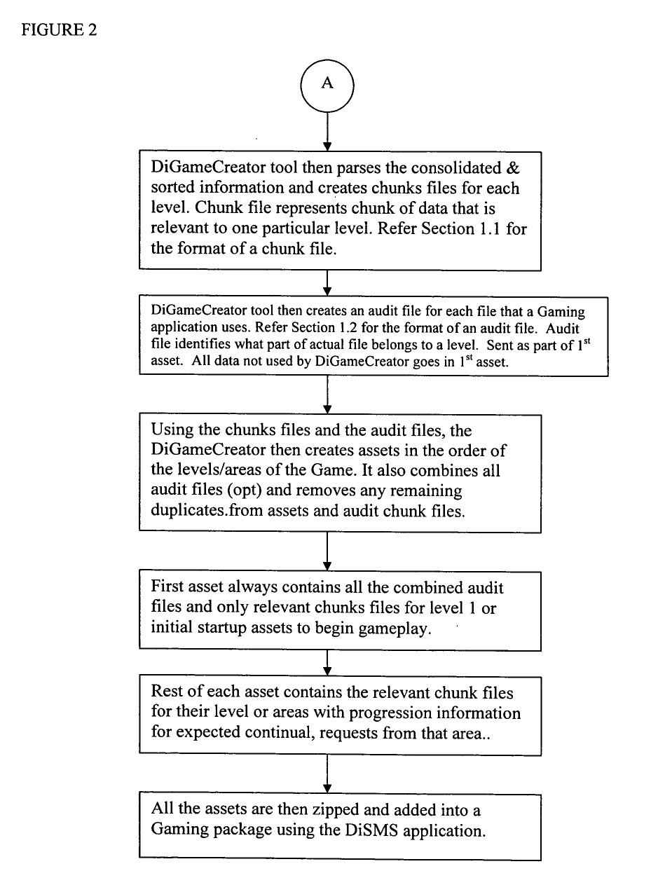

### DETAILED DESCRIPTION OF EMBODIMENTS OF THE INVENTION

A system in accordance with an exemplary implementation of the present invention includes a plurality of nodes (e.g., clients and and server) communicatively connected via a network.

Clients may include one or more game consoles (or computers) with network connectivity means. Each client preferably includes a bus for communicating information, a central processing unit (CPU), a read only memory (ROM), and a random access memory (RAM). Additionally, a mass storage device such as a hard disk, volatile or non-volatile memory and/or other readable and writable storage means, a display device interface and an input device interface are provided. The input device may include a keyboard, pointing device, joystick, game controller and/or other means for inputting data. By way of example, a controller may be coupled to a client game console via a wire or wireless interface. Illustratively, the controller may be equipped with any of a wide variety of user interaction mechanisms, such as thumb sticks, directional pads, surface buttons and triggers. These mechanisms are merely representative, and other known gaming mechanisms may be substituted for or added to those discussed above. These elements of the client are typically included in most computer systems and the aforementioned system is intended to represent a broad category of systems supporting transmission, receipt, storage and processing of video game data in accordance with the present invention.

Of course, the client may include fewer, different and/or additional elements, provided it is capable, when programmed, of performing functions in accordance with the invention. For example, it may be comprised of a digital signal processor (DSP), an application-specific integrated circuit (ASIC), discrete gate logic, or other hardware, firmware, or any conventional programmable software module and a microprocessor in addition to or in lieu of components described above. Client-side software modules could reside in ROM and/or RAM memory, flash memory, registers, or any other form of readable storage medium known in the art. Additionally, the client may either stand alone or operate in a distributed environment.

Each client is communicatively connected to a network such as global computer network (e.g., the Internet), a wide area network (WAN), a local are network (LAN), another network configuration that facilitates communications between the client and a server, or some combination of the foregoing. A network interface implemented on the client provides access to a network and may be any of a wide variety of various wired or wireless interface components including an Ethernet card, a modem, a wireless transceiver (e.g., 802.11) module, a cable or DSL modem, and the like. Clients may be adapted for single-player use, multi-player use, and as a node in a network gaming community.

Functions of a client preferably include communicating with the server and receiving, storing and processing video game data for game play. To perform these functions, clients preferably include an operating system and application software, i.e., one or more client-side programs, that enable users to play games on the client. The client-side programs are preferably adapted to perform client functions and processes as described herein. Among other things, the client-side programs preferably enable communication with a server using a determined protocol to receive video game data. The client-side programs may also manage the receipt, storage and playing of received video game data. Furthermore, the client-side programs may enable interactive functions required for game play.

Video game data may requested and received from the server via network transmission and stored on a hard disk drive in the client. During play, portions of the game data may be temporarily loaded into RAM and executed by a CPU.

One or more server computers (i.e., servers) are communicatively connected to the network via a transmission medium. Functions of a server preferably include processing client requests and transmitting video game data and/or segments thereof. Like the client, the server preferably includes a bus for communicating information, a central processing unit (CPU), a read only memory (ROM), and a random access memory (RAM). Additionally, a mass storage device, a display device and an input device may be provided. The storage device may include a hard disk, tape drive, memory and/or other readable and writable storage means. The input device may include a keyboard, pointing device and/or other means for inputting data. These elements are typically included in most computer systems and the aforementioned system is intended to represent a broad category of systems supporting transmission, receipt, storage and processing of video game data and client requests in accordance with the invention.

Of course, the computer system may include fewer, different and/or additional elements, provided it is capable, when programmed, of performing functions in accordance with the invention. For example, it may be comprised of a digital signal processor (DSP), an application-specific integrated circuit (ASIC), discrete gate logic, or other hardware, firmware, or any conventional programmable software module and a microprocessor in addition to or in lieu of components described above. Server software modules could reside in RAM memory, flash memory, registers, or any other form of readable storage medium known in the art.

Additionally, the server system may either stand alone or operate in a distributed environment. By way of illustration, to achieve a higher transmission capacity and lower long-haul transmission cost, a hierarchical server architecture may be used, in which a plurality of local servers are placed close to users and cache video game data dynamically accordingly to local demand. One or more master servers may provide video game data to the local servers as needed.

As used herein, a video game broadly refers to an interactive graphical computer game. Though a system and method according to the invention will be described with respect to an adventure game, it is to be understood that the invention may be applied to various game genres, including fighting, role-playing and sports games, and the like. Illustratively, an exemplary video game may feature a game character (e.g., a person) or object (e.g., an aircraft) that is maneuvered under the control of a player through scenes in a virtual environment that is displayed by the client on a display screen. Play may involve employing a variety of actions in an attempt to achieve an objective, such as finding an object, winning a race or defeating an opponent. The exemplary game may be configured to provide a player various options and settings, such as allowing a player to select from several different characters or objects, themes and scenery, stages of difficulty and available actions.

A video game, such as the game described above, typically includes a plurality of functionally separable components, meaning certain discrete identifiable portions of a video game program. The components, which may include coding and multimedia data, correspond to conceptually separable scenes, environments, sections, characters, objects, difficulty stages, events, actions, or other game features and elements. A plurality of components may share one or more of the same discrete portions of video program data. Such functionally separable components are referred to herein as assets. The conceptually separable scenes, environments, sections, characters, objects, difficulty stages, events, actions, and other game features and elements to which the assets correspond are referred to herein as “levels,” “program levels,” “game levels” or “levels of play” for reference convenience.

In a preferred implementation of the invention, the server is configured to analyze a conventional multi-level video game to determine the assets required for game play at each level of the game. A list of indices and asset contents is stored in a container on the server to provide a record of the file segments accessed per level. The indices identify the level of play corresponding to each asset. The indices may also identify levels of play accessible from a current level. The server may then make the list available to a client to enable the client to request delivery of assets needed for play at a level of the game.

In an exemplary implementation, a shim is provided on the server to facilitate creation of the list of indices and asset contents for a video game. The shim is preferably adapted to analyze file activity as the video game is executed on the server. By intercepting and distinguishing service requests before they reach the operating system, the shim identifies and associate assets of the video game with levels of play. The service requests specify parameters that enable identification of the assets initiating the requests. A record is created as data structure, using, for example, a pointer and a sequence of bits included in each asset. Thus, the shim converts the video game into a container of discrete assets indexed to levels of play. Using the resulting the container of a plurality of discrete assets and associated indices, video game portions may be identified and transmitted to a client upon request.

A hierarchical relationship may be used to conceptually identify various levels of a multi-level game and the interrelationships between levels. A game level that is currently being used during game play may be considered a current level. A current level may have one or more child levels accessible from the current level. A current level may also have one or more parents from which the current level stemmed. Additionally, a current level may have sibling levels, which share one or more common parents with the current level. If one level may be accessed from another level, the levels are considered directly related. One example of movement from one level to another level during game play is movement from a first room, in which a player is performing actions, into one of possibly several rooms that are directly accessible from the first room. New assets may be required for play in the new room.

Referring now to FIG. 4, a chart is provided that illustrates interrelationships between levels of a game. Level L_{C} represents a current level. Levels P₁, P₂ and Pₙ represent parent levels from which the current level L_{C} can be invoked. Parent levels P₁, P₂ and Pₙ may also be accessed from the current level L_{C}. Levels C₁, C₂ and Cₙ represent child levels which may be invoked from the current level L_{C}. Levels S₁ and S₂ represent sibling levels which share one or more common parents with the current level. Sibling levels, such as S₁, may also be accessible from the current level L_{C}. In general, if a level may be accessed from the current level L_{C}, the current level L_{C} may also be accessed from that level.

During game play, a master list is downloaded to the client from the server. The master list identifies each level, assets corresponding to each level and directly related levels for each level. The master level may also include an end offset of the video game data file. Assets for a first level are also downloaded from the server to a client to commence game play. While the first level is being played, assets corresponding to directly related levels may be downloaded, if they have not already been received. One of the directly related levels is a level for which assets are likely to be needed next to continue game play. An asset is downloaded to the client only once during a game play session. After assets for directly related levels are downloaded, assets for other levels may be downloaded.

An exemplary implementation of the present invention enables archiving and playing downloaded video game data assets while additional assets are being transmitted to the client for archiving and playing. Thus, for example, while received assets are being played by the client, assets that have not yet been received are requested by and transmitted to the client. To enable such functionality, the server preferably receives and processes instructions or commands (i.e., asset requests) sent by the client and responds accordingly.

In an exemplary implementation, a client may maintain two distinct data channels (i.e., separate logical and/or physical communication paths) with a server, such as (1) a COM channel for communicating requests and responses between the server and client and (2) a media channel for receiving assets from the server. Each channel preferably maintains a Transmission Control Protocol/Internet Protocol (TCP/IP) connection with the server. The TCP layer manages the disassembling of a data unit (e.g., a message, asset) into smaller packets (or datagrams) that are efficiently transmitted and routed over the network and the reassembling of received packets into the original data unit. The IP layer handles the address part of each packet so that it reaches the intended destination. Use of the TCP/IP protocol helps to ensure that every packet sent by the server is received by the client. The client may use another protocol to interface with a network access provider as an intermediary. For example, the client may use a Serial Line Internet Protocol (SLIP) or Point-to-Point Protocol (PPP) to encapsulate IP packets so that they can be sent over a transmission medium to a network access provider's system without departing from the scope of the present invention.

Initially, an authorized (e.g., authenticated) client may send a request for a master list and first asset to a server via the COM channel. If the master list and asset is available, the server may begin sending (i.e., downloading to the client) them via the media channel. Upon receiving the master list and first asset, the client may begin playing the game and send a request to the server via the COM channel for an asset directly related to the first asset.

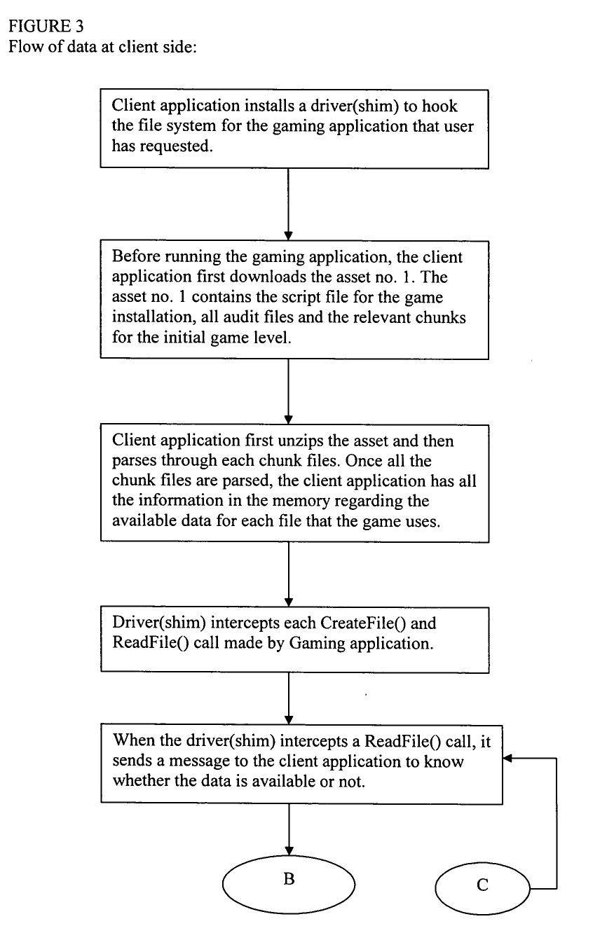

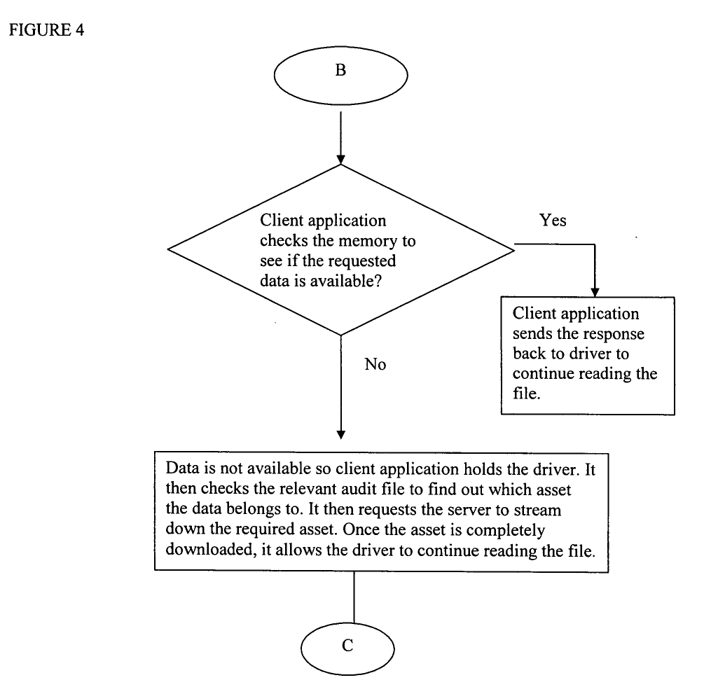

Based upon an end offset of the asset received with the master list via the media channel, the client preferably creates a video game data file of the video game data file size, as conceptually shown in FIG. 3. The first asset (X) may be stored at the beginning of the video game data file, leaving enough storage space for succeeding assets. The remainder of the file may then be filled up with zeros, as shown in FIG. 3, specifying empty data chunks for which assets may eventually be requested.

The client preferably maintains a global list that tracks available assets (e.g., A, X and Z in FIGS. 3 and 4) and empty data (e.g., zeros in FIGS. 3 and 4) chunks. Items of the global list may be structures defined as follows:

struct {

long lFromOffsetId; // defines the Offset from which the data
is available
long lToOffsetId; // defines the Offset to which the data is available

};

When the client receives a first asset, it may enter into the global list a ‘from offset id’ as zero and a number of bytes received as ‘to offset id’. This entry indicates that the asset from ‘from offset id’ to ‘to offset id’ is available at the client (in the video game data file). The client updates the ‘to offset id’ entry in the list as additional assets are received. Until the video game data file is full, the client transmits, via the COM channel, requests to the server to send assets that have not yet been received, as discussed above.

An important advantage of the present invention is that it allows a user to jump to any level in a game irrespective of whether the required asset is available at the client or not for that level. If a user jumps to level for which an asset is unavailable, the client transmits, via the COM channel, a request to the server to begin sending the asset and then waits for the requested asset to arrive to resume play. The delay in play is minimized, because the system waits only for the required asset to arrive to resume play. When the data for the new asset arrives, a new entry may be created in the global list specifying the ‘from offset id’ and ‘to offset id’ and playback may resume. As additional assets are received for other levels, the ‘to offset id’ is updated.

In sum, the client is configured to manage the storage of assets and the master list, requests for needed assets that have not been received, and identification of needed assets that are currently available. While an exemplary implementation for performing these functions is described herein, those skilled in the art will appreciate that other steps may be performed to achieve the same objectives without departing from the scope of the invention.

The client preferably also tracks the merger of new available data with old available data. As new data is received, filling up previously empty chunks, the global list may be updated with each ‘from offset id’ and corresponding ‘to offset id’ entry representing a continuous range of available assets 0. Entries in the global list may be added in an ascending sorted order of ‘from offset id’ 0.

As a user jumps from one level to another level, data may be available in the form of discontinuous chunks. To avoid problems caused by a discontinuity (i.e., encountering an unavailable asset in the video game data file), the client application may check for asset continuity from the video game data file current level onwards. If the available assets are not continuous, the client may sends a request, via the COM channel, to the server to send data for the missing assets required for continuity.

A user can jump to a position in the video game data file such as by maneuvering game play t a new level. The client determines if the targeted data is available (e.g., by checking the global list) before jumping to the new level in the video game data file. Next, the global list is searched to find out whether the data offset for the new level corresponds to an available asset 0-0. If the targeted asset is not available, the client will send a request to the server to begin sending the asset corresponding to a the new level 0. The client then waits for the targeted asset to arrive, and resumes playback 0. In this manner, the system waits only for the assets immediately needed to resume playback. Thus, other assets that are unnecessary for playback will not delay playback.

Those skilled in the art will appreciate that maneuvering of player action through various levels is conducive to formation of discontinuities. The methodology described above directs the server to provide assets to fill empty chunks on a prioritized basis (i.e., assets corresponding to directly related levels are requested first) in the video game data file and facilitate continuous playing from any level in the video game data file, with minimized delay.

When assets for a current level and all directly related levels, the client-side monitoring thread preferably checks the global list to determine if any zeros (unavailable asset) remain. If zeros remain, the client will send a request to the server to begin sending missing assets. For example, the client may send a request, via the COM channel, to the server to send assets corresponding to a next generation of descendant levels of game play, and so on. This process may repeat until the entire video game data file is stored in the video game data file.

The methodology of the present invention reduces (or eliminates) the need for retransmission of available data. The monitoring thread does not request the server to send data that is already available in the video game data file. If assets are available in the video game data file for a selected level, but other data is unavailable, the client will request the unavailable assets from the server. Until the video game data file is full, the client will request unavailable assets by reference to the global list and communication with the server via the COM channel.

By employing two channels for communication with the server, the present invention facilitates a steady stream of video game assets over the dedicated media channel, until the video game data file is full. Requests sent to the server via the COM channel will not interfere with asset downloading.

An important advantage of the present invention is that it accommodates both playback of downloaded video game data on demand in real time and playback of downloaded and stored video. If a user pauses or stops playback of downloading video, the client continues to request, via the COM channel, unavailable data from the server, until the video game data file is full. To illustrate, a user may pause playback by selecting the pause control on a player. Playback will cease. However, the client may continue to request unavailable assets (via the COM channel) and the server will continue to send unavailable assets (via the media channel) until the video game data file is full. The video game data file may then be saved and played at a time convenient to the user. Play may start at any available level.

Another advantage of the present invention is that it preserves the video game data file in the event a connection is lost or terminated. Upon reestablishing a network connection downloading may resume via the media channel and communications may resume via the COM channel.

While the invention has been described in terms of exemplary embodiments, those skilled in the art will recognize that the invention can be practiced with modifications within the spirit and scope of the foregoing detailed description. Such alternative embodiments and implementations are intended to come within the scope of the present invention.

1. A gaming on demand method comprising steps of profiling a game having multiple levels of play to determine segments of a game required for play at a level of the game and at subsequent levels of the game, prioritizing segments of a game to be downloaded at each level such that segments of a game needed immediately to play at a current level are downloaded, and then portions which correspond to levels accessible from the current level are downloaded.
